(19) United States
(12) Patent Application Publication
(10) Pub. No.: US 2016/0139634 A1
(43) Pub. Date: May 19, 2016

(54) HINGE DEVICE

(71) Applicant: SENEKA CO., LTD., Suwon-si (KR)

(72) Inventors: Pil Je CHO, Suwon-si (KR); Young Woo HUH, Suwon-si (KR)

(73) Assignee: SENEKA CO., LTD., Suwon-si (KR)

(21) Appl. No.: 14/929,886

(22) Filed: Nov. 2, 2015

(30) Foreign Application Priority Data
Nov. 19, 2014 (KR) 10-2014-0161666

(51) Int. Cl. G06F 1/16; E05D 7/00

(52) U.S. Cl. CPC G06F 1/1652; G06F 1/1681; E05D 7/00

(57) ABSTRACT

The hinge device according to the present disclosure may include a hinge unit configured to mutually and rotatably connect a first member and a second member, and a first surface of the hinge unit may be continued to at least one surface of a first particular surface of the first member and a second particular surface of the second member.

Pursuant to 35 U.S.C. §119 (a), this application claims the benefit of earlier filing date and right of priority to Korean Patent Application No. 10-2014-0161666, filed on Nov. 19, 2014, the contents of which are hereby incorporated by reference in their entirety.

### BACKGROUND OF THE DISCLOSURE

1. Field

The teachings in accordance with the exemplary embodiments of this present disclosure generally relate to a hinge device configured to connect separately-arranged two members in a rotatable manner.

2. Background

Multiple media devices such as notebooks and mobile phones are generally configured in a folder-type. A notebook is generally configured in a folder type capable of opening and closing a first body unit mounted with a main board and a key board, and a second body unit mounted with a display screen. At this time, a hinge device is mounted at a rotation center between the first body unit and the second body unit.

Meanwhile, unlike the display device according to prior art, a hinge device may create a problem when a recently-favored flexible display is installed in an area capable of covering both the first body unit and the second body unit.

That is, the flexible display may be excessively folded beyond a bending deflection limit sustainable by the flexible display, at a border area between the first body unit and the second body unit where the hinge device is mounted, and length may be changed when the hinge device is rotated to disadvantageously generate a breakage possibility of the flexible display due to receipt of compressive force power or tension.

### SUMMARY

The present disclosure has been made to solve the foregoing disadvantages/problems of the prior art and therefore an object of certain embodiments of the present disclosure is to provide a hinge device configured to constantly maintain a length of a predetermined portion connecting a first member and a second member despite rotation of the first and second members.

Technical problems to be solved by the present disclosure are not restricted to the above-mentioned description, and any other technical problems not mentioned so far will be clearly appreciated from the following description by those skilled in the art.

In order to achieve at least the above objects, in whole or in part, and in accordance with the purposes of the present disclosure, as embodied and broadly described, and in one general aspect of the present invention, there is provided a hinge device, the lens hinge device comprising:

a hinge unit configured to rotatably connect a first member to a second member; wherein a first surface of the hinge unit may be continued to at least one surface of a first particular surface of the first member and a second particular surface of the second member.

In another general aspect of the present disclosure, there is provided a hinge device, the hinge device comprising:

a hinge unit configured to rotatably connect a first member to a second member, both members of which being mounted thereon with a flexible display, and closely contacted to a first surface by the flexible display; wherein the hinge unit may be provided with a plurality of cover blocks arranged along an extended direction of the flexible display to form the first surface, and surfaces forming the first surface at each cover block may be mutually and closely contacted.

In still another general aspect of the present disclosure, there is provided a hinge device, the hinge device comprising:

a hinge unit configured to rotatably connect a first member to a second member, wherein a first particular surface of the first member and a second particular surface of the second member may be mounted with a flexible display, and the hinge unit may be rotated in a manner such that an opposite surface of the first particular surface at the first member may face an opposite surface of the second particular surface at the second member.

### Advantageous Effects of the Invention

The hinge device according to the present disclosure may have a first surface continuous to a particular surface of relatively-rotating first member and a particular surface of a second member.

Thus, when a bendable one object is mounted on a first member and a second member, a relevant object may be securely supported by a hinge device at a section between a first member and a second member, As a result, one object that requires to be supported by a predetermined means across an overall section, e.g., a flexible display, can be mounted on a relatively-rotating plurality of cases.

Furthermore, the hinge device according to the present disclosure may form a first surface using a relatively-rotating plurality of cover blocks. Thus, when a first member and a second member are relatively rotated, a length of an object can be made not to be changed at a section between the first member and the second member.

In addition, when a first member and a second member are overlapped, bending of a first surface can be made to be realized along an arc of a particular circle. As a result, damage of an object having an allowable curvature restrained relative to the bending can be prevented.

### BRIEF DESCRIPTION OF THE DRAWINGS

The accompanying drawings are included to provide a further understanding of the disclosure and incorporated in and constituted as a part of this application, illustrate embodiment(s) of the disclosure, and together with the description, serve to explain the principle of the disclosure. In the drawings:

FIG. 1 is a schematic view illustrating a hinge device according to the present disclosure;

FIG. 2 is a schematic view illustrating a state where another hinge device is unfolded according to the present disclosure;

FIG. 3 is a schematic view illustrating a state where another hinge device is folded according to the present disclosure;

FIG. 4 is a schematic view illustrating a state where still another hinge device is unfolded according to the present disclosure;

FIG. 5 is a schematic view illustrating a state where still another hinge device is folded according to the present disclosure;

FIGS. 6 and 7 are schematic views illustrating an operation of a hinge device according to the present disclosure;

FIG. 8 is a cross-sectional view illustrating a cover portion and a hinge portion according to the present disclosure; and

FIG. 9 is a schematic view illustrating a long hole formed at a hinge portion according to the present disclosure.

### DETAILED DESCRIPTION

Various exemplary embodiments will be described more fully hereinafter with reference to the accompanying drawings, in which some exemplary embodiments are shown.

In describing the present disclosure, certain layers, sizes, shapes, components or features may be exaggerated for clarity and convenience. Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

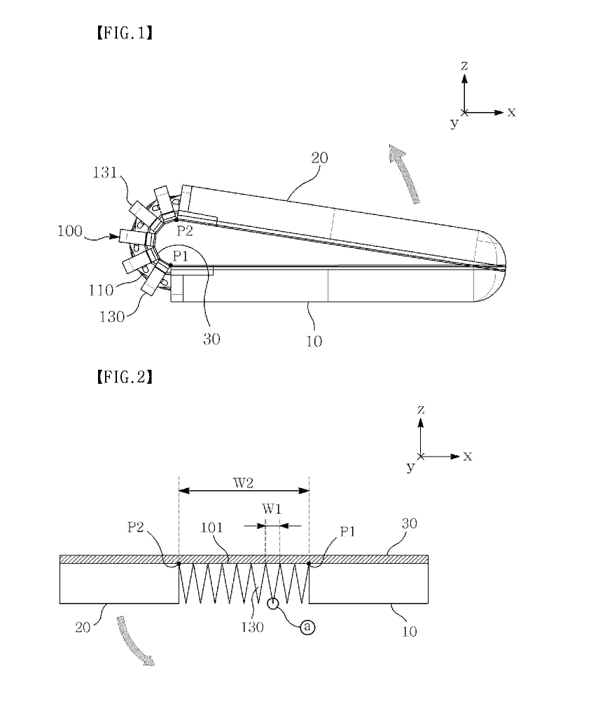

FIG. 1 is a schematic view illustrating a hinge device according to the present disclosure.

The hinge device illustrated in FIG. 1 may include a hinge unit (100).

The hinge device according to the present disclosure may include a support means which becomes a rotation center of a first member (10) and a second member (20). The first member may be a wall, a mobile phone body or a notebook body, and the second member (20) may be a door corresponding to a wall, a display unit corresponding to a mobile phone body, or a display unit corresponding to a notebook body. Alternatively, the first member (10) and the second member (20) may be an object, e.g., a case mounted on a flexible display (30) or a mobile phone/notebook body.

The hinge unit (100) may connect the first member (10) and the second member (20) in a mutually rotatable manner. That is, the hinge unit (100) may support each member to allow the first member (10) and the second member (20) to rotate relative to each other. However, in order to facilitate the explanation and description of the specification according to the present disclosure, description will be made on a state in such a manner that the first member (10) is fixed, and the second member (20) is rotated.

A partial function of connecting the first member (10) to the second member (20) in the hinge unit (100) according to the present disclosure may be similar to that of the conventional hinge. However, the hinge unit (100) according to the present disclosure may include other functions unlike the conventional hinge.

By way of example, one surface of the hinge unit (100) according to the present disclosure may be continued to at least one surface of a particular surface of the first member (10) and a particular surface of the second member (20). At this time, the particular surface of the first member (10) may be defined as a first particular surface and the particular surface of the second member (20) may be defined as a second particular surface. Furthermore, one surface continued to the first particular surface or to the second particular surface in the hinge unit (100) may be defined as a first surface (101).

Furthermore, the meaning of “continued to the first particular surface” may be defined such that the first particular surface of the first member (10) is directly connected to the first surface (101) of the hinge unit (100) at a first position P1 where the first particular surface ends, without any staircase or a height difference. Likewise, the meaning of “continued to the second particular surface” may be defined such that the first surface (101) of the hinge unit (100) is directly connected at a second position P2 where the second particular surface of the second member (20) ends, without any staircase or a height difference.

When the first member (10) and the second member (20) maintain a state of being mutually overlapped according to the foregoing configuration as illustrated in FIG. 1, the first surface (101) may laterally form an arc respectively using a distal end of the first particular surface and a distal end of the second particular surface as a start end and a finish end. Furthermore, as illustrated in FIG. 2, when the first member (10) and the second member (20) maintain a state of 180°, the first surface (101) may laterally be positioned on an extended line of the first particular surface or of the second particular surface.

A flexible display (30), e.g., an OLED (Organic Light Emitting Diode) may be so manufactured as to be flexible. However, a curvature of flexibility may be restrained to a predetermined scope due to technical limit. When the OLED display is mounted on the first member (10) and the second member (20) across a hinge, a serious curve (bend) may be formed at each member and a staircase portion of the hinge. As a result, the OLED display may be damaged. Even if the OLED display is not damaged, it is not preferable for a viewpoint of a user who views an OLED display because the user may view a seriously curved screen of the OLED display. Furthermore, when an OLED display is added by a touch means, it may be difficult to apply a touch input at a portion where the OLED display is seriously bent or curved.

However, according to the present disclosure, the first surface (101) may be closely contacted by an object such as the flexible display (30) extended from at least one surface of the first particular surface or the second particular surface without any serious curve or bend. Hence, the hinge device according to the present disclosure can improve the satisfaction of a user because the damaged problem of the display can be prevented.

The first surface (101) may be extended at a length W2 from a distal end P1 of the first particular surface to a distal end P2 of the second particular surface. At this time, it is advantageous that W2 is not changed and maintained at a constant length. This is because the flexible display (30) may be flexible in its characteristics, but may be difficult in being elastic. When an object of these characteristics is mounted on the W2-variable first surface (101) in response to rotation of the first member (10) and the second member (20), the first member (10) or the second member (20) may be restricted in rotation by a relevant object, or the object may be folded in a wrinkled crumpled manner or disconnected by the rotation of the first member (10) and the second member (20). Even if the flexible display (30) is flexible along an extended direction, it may cause an inconvenience to a user using the display (30), which is not advisable.

The hinge unit (100) according to the present disclosure, may be provided with a hinge portion (110) configured to connect the first member (10) to the second member (110), and a cover portion (130) forming the first surface (101). At this time, the cover portion (130) may be integrally formed with the hinge portion (110) or may be formed separately from the hinge portion (110).

The hinge portion (110) may be in a state of lubricant being spread on a particular portion for smooth hinge function. Thus, the cover portion (130) is preferable to be provided separately from the hinge portion (110) in order to prevent an object closely contacted to the first surface (101) from being contaminated by the relevant lubricant. Of course, it would be possible for the cover portion (130) to be integrally formed with the hinge portion (110) if there is a sufficient measure against the relevant lubricant.

In order to maintain the length W2 of the first surface (101) as constant, the cover portion (130) may include a plurality of cover blocks (131) arranged along a direction perpendicular to a rotation shaft of the first member (10) and the second member (20). To be more specific, the direction to which the cover blocks (131) are arranged may be same as an extended direction of the flexible display (30) extended across the first member (10) and the second member (20).

Furthermore, each cover block (131) may be so formed as to allow relatively and mutually rotating in order for the length W2 of the first member (101) to be maintained as constant when the first member (10) or the second member (20) is rotated. When the length W2 is maintained as constant by the cover block (131), the flexible display (30) may be coupled or fixed to each cover block (131) beyond the level of being closely contacted to each cover block (131).

The cover portion (130) in FIG. 1 may include five (5) cover blocks each having a cross-section of square shape. At this time, a surface portion forming the first surface (101) at the five cover blocks (131), i.e., a particular surface cross-sectionally or laterally opposite to the first surface (101) may be in a state of being closely contacted to the flexible display (30). At this time, the length W2 of the first surface (101) may be constantly maintained regardless of the relative rotation of the first member (10) and the second member (20) when a particular side of the cover block (131) is made to maintain a closely contact state with another cover block (131) through the cover portion (130) or the hinge portion (110).

The first surface (101) may be formed in FIG. 1 by five (5) particular sides that are continuously arranged on an extended direction of the flexible display (30). At this time, a length W1 of each particular side may be same as a value in which W2 is divided by 5, which is the number of cover blocks.

Meanwhile, when the first particular surface arranged with the flexible display (30) and the second particular surface are folded to face each other as shown in FIG. 1, it may be difficult to bring the first member (10) and the second member (20) into a complete contact. This is because it may pass a curvature scope allowable by the flexible display. Thus, it would be preferable that P1 and P2 be distanced in order to satisfy the allowable curvature. However, the shape of the first member (10) and the second member (20) being overlapped in a mutually loose (curled-up, come-off) state in order to satisfy the distance condition between P1 and P2 as illustrated in FIG. 1 may destroy a beautiful external look. In addition, the hinge unit (100) may be damaged, or the first member (10) or the second member (20) may be damaged by a pressure applied to a direction (z axis direction in FIG. 1) perpendicular to each member in a case of a mobile phone under an environment where the mobile phone is accommodated into a pocket in a state of being overlapped.

Thus, it may be preferable to provide an environment in which the first member (10) and the second member (20) are overlapped in a complete close contact while the distance condition between P1 and P2 is satisfied.

By way of example, when one flexible display (30) is mounted on the first particular surface of the first member (10) and the second particular surface of the second member (20), the hinge unit (100) may be so rotated as to allow an opposite surface of the first particular surface to mutually face an opposite surface of the second particular surface, whereby the first member (10) and the second member (20) may be overlapped so as to be in close contact while satisfying the distance condition between P1 and P2.

However, to this end, the second member (20) disclosed in FIG. 1 needs to be rotated 360° to an arrow direction (counterclockwise direction). Meanwhile, in view of the fact that each cover block (131) in FIG. 1 takes a square shape in cross-section, it is difficult for each cover block (131) to rotate anymore because each cover block acts as a stopper after the second member (20) is rotated to an arrow direction (counterclockwise direction) to form a 180° with the first member (10).

This type of problem may be solved by deformation of a cross-section of the cover block (131) to a particular shape.

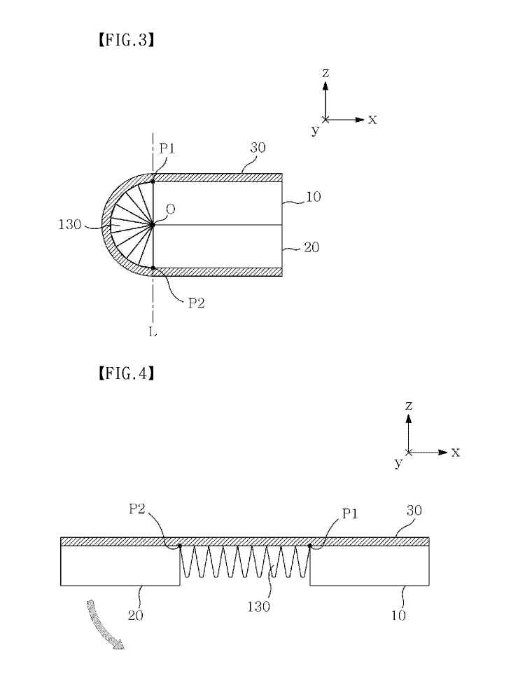

FIG. 2 is a schematic view illustrating a state where another hinge device is unfolded according to the present disclosure, and FIG. 3 is a schematic view illustrating a state where another hinge device is folded according to the present disclosure. FIGS. 2 and 3 illustrate schematic views of cross-sections of the hinge device.

A cross-section of the cover block (131) illustrated in FIG. 2 may take a triangular shape forming, by a particular side, a part of the first surface (101). According to this configuration, the phenomenon of the first member (10) being mutually overlapped by the second member (20) by counterclockwise rotation of the second member (20) in the drawing may not be restrained by the cover block (131). Furthermore, according to the triangular cross-section, the first surface (101) may not be fluttered in the open air while the first member (10) is mutually overlapped by the second member (20). Because when the first member (10) and the second member (20) are mutually overlapped, other two sides except for the particular side in the cross-sectional shape of the cover block (131) can be closely contacted to the other cover blocks. At this time, the flexible display (30) closely contacted to each cover block (131) may be prevented from being fluttered in the air because mutually contacted cover blocks (131) may be fixed in a particular shape.

It is preferable that the particular shape be a circle, if possible, to allow the curvature of the first member (101) to be gentle because the curvature of the first surface (101) may be suddenly changed in response to the particular shape. The particular shape may be determined by a position of an apex formed by two sides except for a particular side in each cover block (131).

A cross-sectional shape of each cover block (131) may take a shape of a particular circle radially cut out as shown in FIG. 3 to allow each cover block to form a circle while two sides are closely contacted. Nevertheless, it is preferable that a particular side forming the first surface (101) at each cover block (131) be a straight line instead of an arc. This is because a sudden curve or bend may be generated between each particular side when the cover portion (130) is rotated in clockwise direction. Particularly, this type of phenomenon may be seriously generated when the first member (10) and the second member (20) are overlapped as shown in FIG. 1. However, there is no problem when the particular side is a straight line.

A cross-section of each cover block (131) may take a triangular shape when the cover block (131) formed by radially cutting out a particular circle in FIG. 3 is unfolded as shown in FIG. 2. At this time, an apex of each triangle may form a center 0 of a particular circle when the first member (10) and the second member (20) are overlapped.

According to this configuration, the first surface (101) may be bent to naturally follow an arc of the particular circle by the cover block (131) at a particular rotation angle between the first member (10) and the second member (20).

The particular rotation angle at this time may be a state where an opposite surface of the first particular surface at the first member (10) and an opposite surface of the second particular surface at the second member (20) face each other in parallel. When a radius of a particular circle is equal to a sum in which a thickness of the first member (10) is added by a thickness of the second member (20), the opposite surface of the first particular surface at the first member (10) and the opposite surface of the second particular surface at the second member (20) can be completely and tightly contacted.

An imaginary line L may be set in order to define in detail the state in which the opposite surface of the first particular surface at the first member (10) and the opposite surface of the second particular surface at the second member (20) face each other in parallel. The imaginary line L can connect the first position P1 and the second position P2 while the first member (10) and the second member (20) face each other in parallel. At this time, the hinge unit (100) may be arranged at one side of the imaginary line based on the imaginary line L. Furthermore, a center O of the particular circle may be arranged on the imaginary line L. This state cannot be satisfied when the first particular surface and the second particular surface face each other as in FIG. 1, because the center O of the particular circle cannot be defined in FIG. 1.

Meanwhile, apex portions \textcircled{a} may interfere with each other, because all the apex portions \textcircled{a} in each cover block (131) at the cross-section of the triangle gather at the center O of the particular circle. The shape of particular circle may be deformed by the interference at this time. In order to prevent this phenomenon, each cover block (131) may have a cut-out shape at a distal end facing the center O of the particular circle.

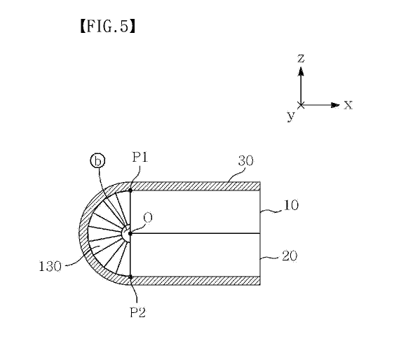

FIG. 4 is a schematic view illustrating a state where still another hinge device is unfolded according to the present disclosure, and FIG. 5 is a schematic view illustrating a state where still another hinge device is folded according to the present disclosure.

Referring to FIGS. 4 and 5, a cross-section of each cover block (131) may take an isosceles trapezoidal shape. At this time, a bottom side of the isosceles trapezoid may form a part of the first surface (101), whereby, when the first member (10) and the second member (20) are arranged at a particular rotation angle, both sides may be tightly and closely brought into contact with adjacent other cover blocks (131) at a cross-sectional shape of the cover block (131). In addition, the mutual interference phenomenon at the center O of the particular circle can be effectively prevented, because the apex portion \textcircled{a} of FIG. 2 becomes in a state of being ruled out.

Under this state, when the first member (10) and the second member (20) are overlapped, an empty space \textcircled{b} may be formed near the center O of the particular circle as illustrated in FIG. 5. The interference between the each cover block (131) can be solved by the empty space \textcircled{b} in the first place.

Furthermore, there may be generated a problem caused by a tolerance per se of each cover block (131) or an arrangement tolerance, and in order to solve the tolerance, there is a need of a part of the cover block (131) squeezing out toward the center O. If there is provided no empty space \textcircled{b}, the problematic part of the cover block (131) cannot squeeze out toward the center O, and therefore may squeeze out toward an opposite direction, i.e., squeeze out toward the first surface (101). This phenomenon can damage the gentle gradual curve of the first surface (101), which is not advisable. Furthermore, a relevant cover block (131) may apply a pressure to the flexible display (30) mounted at the first surface (101) to a damageable degree while the first member (10) and the second member (20) are rotated. However, when the empty space \textcircled{b} is provided, the problematic cover block (131) can squeeze out through the empty space \textcircled{b} instead of the first member (101), whereby the curve of the first member (101) and the flexible display (30) may be prevented from being damaged.

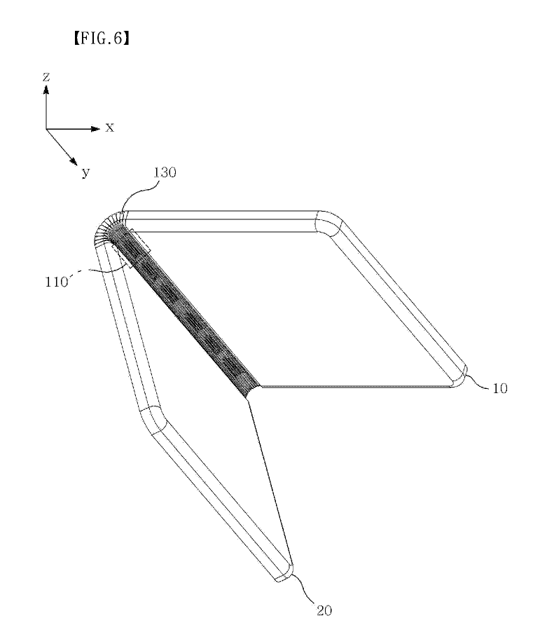

FIGS. 6 and 7 are schematic views illustrating an operation of a hinge device according to the present disclosure, where FIG. 6 illustrates a state where the first member (10) and the second member (20) are partially unfolded, and FIG. 7 illustrates a state where the first member (10) and the second member (20) are mutually overlapped by the second member (20) rotating to a counterclockwise direction.

Referring to FIG. 6, the cover portion (130) may form an external shape of the hinge unit (100). Externally, the hinge portion (110) may be hardly seen by being covered by a plurality of cover blocks (131) that form the cover portion (130). Now, referring to FIG. 7, it can be noted that the opposite surface of the first particular surface at the first member (10) mounted with the flexible display (30) and the opposite surface of the second particular surface at the second member (20) are completely and tightly contacted.

Meanwhile, the plurality of cover blocks (131) may be integrally formed on a flexible substrate such as a rubber plate forming the first surface (101). However, the flexible substrate may be problematically shrunken or deformed in its length by frequent rotation. Thus, it is preferable that each cover block (131) be independently provided, if possible.

Meanwhile, the independently provided cover blocks (131) may flutter (may be pliable) between the first member (10) and the second member (20). Thus, the hinge portion (110) may be utilized in order to prevent this fluttering phenomenon.

The hinge portion (110) may be basically a means configured to directly connect the first member (10) and the second member (20). At this time, the mutually dividable cover blocks (131) may be supported to the hinge portion (110).

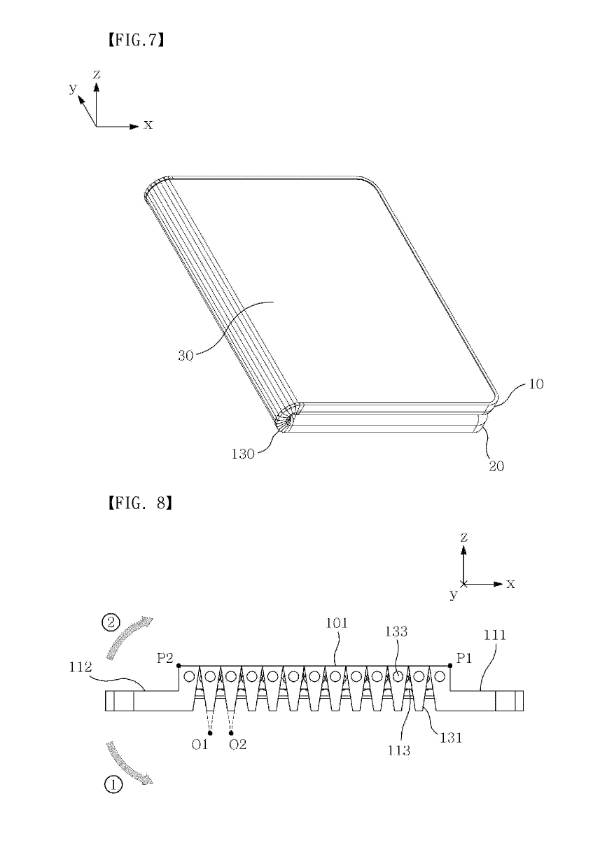

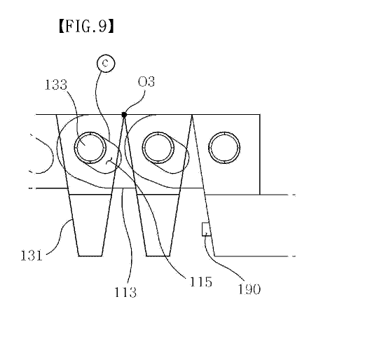

FIG. 8 is a cross-sectional view illustrating the cover portion (130) and the hinge portion (110) according to the present disclosure, where the cover portion (130) and the hinge portion (110) are shown while the first member (10) and the second member (20) are unfolded at 180°.

The hinge portion (110) is formed with one rotation shaft, such that it is difficult to support the cover block (131) in order to constantly maintain the length W2 of the first surface (101). Thus, the hinge portion (110) is arranged in plural along a direction facing the second member (20) from the first member (10), and may include mutually linked hinge blocks (113). Furthermore, the hinge portion (110) may be provided at one distal end with a first fastening portion (111) coupled to the first member (10), and at the other distal end with a second coupling portion (112) coupled to the second member (20).

Furthermore, each cover block (131) may be provided at a position different from that of the first member (101) with a support shaft (133). By way of example, the support shaft (133) may be arranged to a z direction at a position different from that of the first member (10) when the cover portion (130) is unfolded in the shape of ‘1’. The support shaft (133) at this time may be parallel with a relative rotation shaft between the first member (10) and the second member (20) or a rotation shaft of the hinge portion (110).

As discussed in the foregoing, each cover block (131) may be extended toward particular positions O1, O2 distanced from the first surface (101). The particular positions O1, O2 at this time may correspond to apexes of each cross section of a triangle. Thus, width W1 of each cover block (131) may decrease toward the particular position. Furthermore, each particular position is set at each cover block (131), and the plurality of positions O1, O2 and the like may have a same value in a state where the first member (10) and the second member (20) are overlapped by relative rotations. The same value at this time may conform to the center O of the aforesaid particular circle.

According to this configuration thus described, when the second coupling portion (112) is rotated to a counterclockwise direction \textcircled{1} in FIG. 8, the particular positions O1, O2 and the like may get closer mutually, which means that the support shaft (133) provided at the each cover block (131) moves to a mutually closing direction because the length at a portion forming the first surface (101) at the cover block (131) remains unchanged.

A long hole (115) movably supporting the support shaft (133) may be provided at the hinge block (113) in order to guarantee the movement of the support shaft (133). According to the long hole (115), the support shaft (133) provided at each cover block (131) may get mutually closer or may get mutually distanced. In the latter case may be generated when the second member (20) is rotated to a clockwise direction \textcircled{2}.

FIG. 9 is a schematic view illustrating a long hole (115) formed at the hinge portion (110) according to the present disclosure.

The movement of support shaft (133) provided at each cover block (131) is not realized randomly but may be realized along an imaginary arc using a position 03 between each cover block (131) on the first surface (101) as a center.

Hence, the long hole (115) is preferred to be extended along the imaginary arc using the position O3 as the center. Furthermore, the length of the long hole (115) may determine a rotation scope of the second member (20) that rotates to the clockwise direction \textcircled{2}. When the length of the long hole (115) is sufficiently long, the second member (20) may be rotated to a position where the first particular surface and the second particular surface face each other.

Meanwhile, although it seems preferable that the support shaft (133) be positioned at O3, the reality is not as such, because it is difficult to arrange the center of the support shaft (133) on the first surface.

According to the hinge device of the present disclosure, one continuous flexible display (30) may be mounted across the first particular surface at the first member (10), the second particular surface at the second member (20) and the hinge unit (100). At this time, a first area arranged on the first particular surface in the relevant flexible display (30), a second area arranged on the second particular surface and a third area opposite to the hinge unit (100) may form a single display area.

By way of example, one image data is displayed on the flexible display (30), a relevant image data may be displayed using the first area, the second area and the third area as a so-called one screen. To be more specific, an area of the first area arranged on the first particular surface may be a, an area of the second area arranged on the second particular surface may be b, and an area of the third area arranged on the hinge unit (100) may be c. One image data may be displayed on an area d=a+b+c in which a, b and c are all added up.

When the first particular surface and the second particular surface are rotated to face each other by the hinge unit (100), the relevant flexible display (30) may be turned off when the first particular surface and the second particular surface are overlapped, and the relevant flexible display (30) may be turned on when the overlapped state is released.

Meanwhile, when the hinge unit (100) is rotated to allow the opposite surface of the first particular surface at the first member (10) and the opposite surface of the second particular surface at the second member (20) to face each other, another operation may be required. In this case, even if the first member (10) and the second member (20) are overlapped, a user can ascertain at least the first area or the second area on the flexible display (30).

By way of example, it is imagined that the first member (10) and the second member respectively have a size of a smart phone, and a user supports the second member (20) with one hand while the first member (10) and the second member (20) are folded.

At this time, the first area of the flexible display (30) arranged on the first particular surface of the first member (10) may be in a state of being exposed to an outside. Furthermore, the second area arranged on the second particular surface may be in a state of being covered by a hand of the user.

Under these circumstances, it may not be preferable that the flexible display be turned on or turned off onto a ‘d’ area unit in which the first area, the second area and the third area are all added up. This is because, when one image data is displayed on a ‘d’ area, a user, who is capable of ascertaining only the first area, cannot but ascertain a state of an image data in which a part thereof is cut off. Conversely, when an entire flexible display (30) is turned off, it may be absurd because at least the useable first area is also turned off.

Thus, it is preferable that turn-on and turn-off of the first area and the second area on the flexible display (30) be selectively realized. When the flexible display (30) can selectively turn on or turn off each area, background information capable of determining the selective turn-on/off is required. In order to obtain the background information at this time, the hinge device may be provided with a grasping portion (190).

The grasping portion (190) may grasp a covering degree of the first area of the flexible display (30) arranged on the first particular surface or a covering degree of the second area of the flexible display arranged on the second particular surface. At this time, the grasping portion (190) can grasp a covering degree of the first area of the flexible display (30) arrange on the first particular surface or a covering degree of the second area of the flexible display (30) arranged on the second particular surface. At this time, the covering degree may show how much the first area or the second area is visually covered when a user possessing the first member (10) and the second member (20) views the first area or the second area.

Furthermore, when the covering degree satisfies a first set value, the first area and the second area may form one display area. If the covering degree satisfies the first set value and another second set value, only one of the first area and the second area may form a display area. The covering degree may be variably grasped.

By way of example, the grasping portion (190) may include touch grasping means such as a touch sensor configured to grasp a touch scope of the first area or the second area of the flexible display (30). When a user supports the second member (20) using one hand, it is general that a palm may broadly touch or contact the second particular surface or the second area. The grasping portion (190) may determine, using this phenomenon, that a relevant area is covered by a palm or a floor (bottom) of a particular fixture, when a touch scope of each particular surface or a touch scope of each area satisfies a set value.

Furthermore, the flexible display (30) can turn off the second area determined as being visually covered, and use only the first area as the display area. In this case, one image data may be displayed only on the first area. A relevant image data may be in a state of being shrunken to a size of the first area from a size in which the first area and the second area are added up.

Although the foregoing discussion has described that the grasping portion (190) generates measurement information, and the covering degree is determined by using the measurement information, it is possible to transmit to a separate controller (not shown) configured to determine a covering degree while the grasping portion (190) generates only the measurement information such as touch scope.

By way of another example, the grasping portion (190) may include an illumination grasping means such as an illumination sensor configured to grasp light velocity applied to the first area or the second area from outside, and a touch grasping means configured to grasp a touch scope of the second area. When the second member (20) is placed on a particular fixture, the light velocity of a second measurement surface of the second area may be reduced. Thus, when the light velocity is reduced to satisfy a set value, the grasping portion (190) may determine that the second area is visually covered.

By way of still another example, the grasping portion (190) may include an angle grasping means configured to grasp a rotation angle between the first member (10) and the second member (20), or a rotation angle of the hinge unit (100).

The angle grasping means may grasp the rotation angle using various methods. By way of example, a switch may be provided on another cover block, another hinge block, the first member (10) or the second member (20) using a phenomenon in which a particular cover block (131) or a particular hinge block (113) is closely brought into contact with another cover block, another hinge block or each member (10, 20) while the hinge unit (100) is rotated. A relevant switch may be depressed by a particular cover block (131) or a particular hinge block (113) that rotates at a particular angle. That is, when the switch is depressed, the relevant switch may become an angle grasping means because it can be learned that the particular cover block (131) or the particular hinge block (113) has been rotated at a particular angle.

To be more specific, when a relevant switch is depressed, the first member (10) and the second member (20) come to be a state of being much folded, such that only one of the first member and the second member may be operated. If a relevant switch is released of depression, the first member (10) and the second member (20) come to be a state of being unfolded, such that both the first member (10) and the second member (20) are operated to form one single display area.

Meanwhile, when one of the first area and the second area is ruled out from the display area according to a user selection, the third area facing the hinge unit (100) may be included in the display area or ruled out from the display area according to the user selection.

According to the grasping portion thus described, when folded half, it may be a general smart phone, and when unfolded, a multimedia terminal that becomes a tablet PC may be provided.

While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

What is claimed is:

1. A hinge device, the lens hinge device comprising:
a hinge unit configured to rotatably connect a first member to a second member; wherein a first surface of the hinge unit is continued to at least one surface of a first particular surface of the first member and a second particular surface of the second member.

2. The hinge device of claim 1, wherein the first surface of the hinge unit is closely contacted to a flexible display extended from at least one of the first particular surface and the second particular surface.

3. The hinge device of claim 1, wherein the hinge unit is provided with a cover portion configured to form the first surface, the cover portion includes plurally-arranged cover blocks, and each cover block is rotated relative to the other cover block in order to constantly maintain a length of the first surface when the first member or the second member is rotated.

4. The hinge device of claim 1, wherein the hinge unit is provided with a plurality of cover blocks, each cover block is arranged along a direction perpendicular to rotation shafts of the first member and the second member, and a portion forming the first surface at the cover block is closed contacted to the other cover block.

5. The hinge device of claim 1, wherein the hinge unit is provided with a plurality of cover blocks forming the first surface, a cross-section of each cover block takes a shape radially cutting a particular circle, and the first surface is bent by the cover block to follow an arc of the particular circle, when the first member or the second member is rotated to allow an opposite surface of the first particular surface at the first member to face an opposite surface of the second particular surface at the second member.

6. The hinge device of claim 5, wherein the hinge unit connects a first position of the first member to a second position of the second member, and the hinge unit is arranged at one side of an imaginary line and a center of the particular circle is arranged on the imaginary line, based on the imaginary line connecting the first position to the second position while the first member and the second member face each other in a parallel manner.

7. The hinge device of claim 5, wherein a radius of the particular circle is equal to a sum of a thickness of the first member and a thickness of the second member.

8. The hinge device of claim 5, wherein each cover block takes a shape of a cut-out distal end facing a center of the particular circle.

9. The hinge device of claim 1, wherein the hinge unit is provided with a plurality of cover blocks forming the first surface, a cross-section of each cover block takes a shape of a triangle forming, by one side, a part of the first surface, and other two sides in the cross-section of the cover block are closely contacted to adjacent other cover blocks.

10. The hinge device of claim 1, wherein the hinge unit is provided with a plurality of cover blocks forming the first surface, a cross-section of each cover block takes a shape of an isosceles trapezoid forming, by a bottom side, a part of the first surface, and both sides in the cross-sectional shape of the cover block are closed contacted to the other adjacent cover blocks when the first member and the second member are arranged at a particular angle.

11. The hinge device of claim 1, wherein the hinge unit is provided with a hinge portion configured to connect the first member to the second member and a cover portion forming the first surface, wherein,
the hinge portion includes plurally-connected, and mutually-linked hinge blocks along a direction facing the second member from the first member,
the cover portion includes plurally-arranged cover blocks along a direction arranged with the hinge blocks,
the cover block is provided with a support shaft at the first surface and the other positions, and the hinge block is provided with a long hole configured to movably support the support shaft, and
the long hole is extended from the first surface along an imaginary arc about between each cover block.

12. A hinge device, the hinge device comprising:
a hinge unit configured to rotatably connect a first member to a second member, both members of which being mounted thereon with a flexible display, and closely contacted to a first surface by the flexible display; wherein the hinge unit is provided with a plurality of cover blocks arranged along an extended direction of the flexible display to form the first surface, and a surface forming the first surface at each cover block is mutually and closely contacted.

13. The hinge device of claim 12, wherein the cover block is extended toward a particular position distanced from the first surface, a width of the cover block decreases toward the particular position, each particular position is set at each cover block, and each of the plurality of particular positions has a same value while the first member and the second member are overlapped by relative rotation.

14. A hinge device, the hinge device comprising:
a hinge unit configured to rotatably connect a first member to a second member, a first particular surface of the first member and a second particular surface of the second member are mounted with a flexible display, and the hinge unit is rotated in a manner such that an opposite surface of the first particular surface at the first member faces an opposite surface of the second particular surface at the second member.

15. The hinge device of claim 14, wherein a display area is formed by a first area arranged on the first particular surface, a second area arranged on the second particular surface and a third area opposite to the hinge unit.

16. The hinge device of claim 14, wherein the hinge device further comprises a grasping portion configured to grasp a covering degree of a first area of the flexible display arranged on the first particular surface or a second area of the flexible display arranged on the second particular surface, wherein, when the covering degree satisfies a first set value, the first area positioned on the first particular surface on the flexible display and the second area positioned on the second particular surface form a display area, and when the covering degree satisfies a second set value different from the first set value, only one of the first area and the second area forms the display area.

17. The hinge device of claim 16, wherein the grasping portion includes at least one of an angle grasping means configured to grasp a rotation angle between the first member and the second member, or a rotation angle of the hinge unit, an illumination grasping means configured to grasp light velocity applied to the second area, and a touch grasping means configured to grasp a touch scope of the second area.
